(19) United States
(12) Patent Application Publication
(10) Pub. No.: US 2018/0225783 A1
(43) Pub. Date: Aug. 9, 2018

(54) DETERMINING AND DEPICTING PROPERTY CHARACTERISTIC DISTRIBUTIONS IN UPDATABLE SUB-MARKETS FOR A SUBJECT PROPERTY

(71) Applicant: Fannie Mae, Washington, DC (US)

(72) Inventors: Robert D. Martin, McKinney, TX (US); Eric L. Rosenblatt, Derwood, MD (US); Usha Chatarpaul, Potomac Falls, VA (US); Felix Meale, North Bethesda, MD (US); Timothy Staudenmaier, Kensington, MD (US)

(21) Appl. No.: 15/423,805

(22) Filed: Feb. 3, 2017

(51) Int. Cl. G06Q 50/16; G06F 17/30

(52) U.S. Cl. CPC G06Q 50/16; G06F 17/30368

(57) ABSTRACT

A subject property and a corresponding default pool of property sales are determined as a general market for the subject property. Revised property characteristics are submitted to define a new sub-market for the subject property. In connection with this, a map image is displayed depicting the subject property along with properties included and excluded from the sub-market. Functional relationships between selectable property characteristics for the general market and the sub-market are generated, and graphs depicting the same are rendered accordingly. In one example, the distribution of any selectable property characteristic for the general market and the sub-market are concurrently displayed in a graphical image. Interfaces are also provided for individually including and excluding properties from a sub-market.

### BACKGROUND OF THE INVENTION

### 1. Field of the Invention

This application relates to analysis of potential comparable properties for a subject property and more particularly to automatically determining and depicting property characteristic distributions in updatable sub-markets for a subject property.

### 2. Description of the Related Art

Appraisals are traditionally performed by human appraisers who assess a subject property and apply various factors to identify a small set of comparable properties among many recent and nearby sales, with only the identified comparables used to value the subject property. The results may be described in an appraisal report listing the comparable properties but not the potential comparables bypassed. One issue in creating and assessing appraisals is assessing the pool of properties from which the comparable properties were selected. A pool of comparable properties appropriate for a subject property is also referred to as a market for the subject property herein. A broad-based default pool may be referred to as a general market, and a more refined pool may be referred to as a sub-market. For example, the sub-market may be winnowed down from the general market by distance, time, or any property characteristic.

Another issue is that traditional techniques for creating appraisals are inconsistent and incomplete. Automated valuation models have been developed to accommodate a review of comparable properties, as well as a valuation of a subject property, whether in an appraisal report or otherwise. Additionally, map images depicting properties have been implemented. However, use of such map images and corresponding valuations has tended to be limited to depicting an existing geographical area, along with whatever properties are found within that geographical area. This offers insufficient flexibility with respect to reviewing and assessing potential pools of comparable properties, for any given subject property.

Additionally, map images depicting potential comparable properties to a subject property offer insufficient indication as to the factors that merited inclusion (or exclusion) of any given property from an existing pool of comparable properties.

What is needed are techniques for quickly and accurately reviewing pools of property sales as potential comparable properties for subject properties. What is also needed is an improved ability to manipulate and update sub-markets of properties for subject properties. What is also needed are graphical tools for readily indicating characteristics of properties included in updated sub-markets, along with the ability to specifically include or exclude individual properties with stored explanatory information.

### SUMMARY OF THE INVENTION

According to one aspect of this disclosure, a subject property and a corresponding default pool of property sales are determined as a general market for the subject property. Revised property characteristics are submitted to define a new sub-market for the subject property. In connection with this, a map image is displayed depicting the subject property along with properties included and excluded from the sub-market. Functional relationships between selectable property characteristics for the general market and the sub-market are generated, and graphical displays depicting the same are rendered accordingly. In one example, the distribution of any selectable property characteristic for the general market and the sub-market are concurrently displayed in a graphical display. Interfaces are also provided for individually including and excluding properties from a sub-market.

The present invention can be embodied in various forms, including business processes, computer implemented methods, computer program products, computer systems and networks, user interfaces, application programming interfaces, and the like.

### BRIEF DESCRIPTION OF THE DRAWINGS

These and other more detailed and specific features of the present invention are more fully disclosed in the following specification, reference being had to the accompanying drawings, in which:

FIGS. 1A-B are block diagrams illustrating examples of systems in which a comparable property analysis application operates.

FIG. 2 is a flow diagram illustrating an example of a process for updating a pool of property sales.

FIG. 3 is a flow diagram illustrating an example of a process for ranking and displaying property sales, with updates to the pool of potential comparables according to filtered property characteristics.

FIG. 4 is a block diagram illustrating an example of a comparable property analysis application.

FIG. 5A is a display diagram illustrating an example of a subject property, a map image and corresponding property grid data for a list of property sales as potential comparable properties.

FIG. 5B is a display diagram illustrating an example of a map image updated to include an interface with a filterable listing of property characteristics.

FIGS. 6A-C are respective display diagrams illustrating the interface before and after updates to the property characteristics filters.

FIG. 7 is a display diagram illustrating an example of a map image that has updated according to the generation of an updated pool of recent sales/potential comparables, following updates to the property characteristics filters.

FIGS. 8A-B are respective display diagrams illustrating an update to an automated valuation of a subject property following an update to the property characteristics filters and a corresponding change in the pool of potential comparables and the corresponding sub-market.

FIG. 9 is a display diagram illustrating a subject property alongside a map image of a current sub-market and graphical depictions of property characteristics information.

FIGS. 10A-B are respective display diagrams illustrating respective instances of property characteristics distribution with sub-market revision.

FIG. 11 is a display diagram illustrating a subject property alongside a map image of the current sub-market and a property listing with options for selecting individual properties for inclusion in and exclusion from the sub-market.

FIG. 12 is a display diagram illustrating an included property within a sub-market along with a corresponding special indicator.

FIG. 13 is a flow diagram illustrating an example of determining and depicting property characteristic distributions in updatable sub-markets for a subject property.

FIG. 14 is a flow diagram illustrating an example of displaying map images of sub-markets and receiving and recording inclusion and/or exclusion information for individual properties.

### DETAILED DESCRIPTION OF THE INVENTION

In the following description, for purposes of explanation, numerous details are set forth, such as flowcharts and system configurations, in order to provide an understanding of one or more embodiments of the present invention. However, it is and will be apparent to one skilled in the art that these specific details are not required in order to practice the present invention.

According to one aspect of this disclosure, a subject property and a corresponding updatable pool of recent property sales as potential comparable properties are displayed using property data and map imagery. An interface is configured to receive an identification of a subject property, and then to provide displays of map images including an updatable geographical area in which the subject property resides. The subject property is preferably displayed within the geographical area using a first graphical indicator to provide a visual distinction of its location on the map image. At the same time, property sales are displayed within the geographical area using a second graphical indicator that is distinct from the first graphical indicator.

The pool of property sales can be filtered using an interface having various property characteristics and configurable ranges for those characteristics. First, a request to filter the property sales is received, and in response to receiving the request, an interface with the configurable property characteristic ranges appears alongside the map image depicting the property sales.

The interface is configured to receive input to alter the ranges of the various property characteristics. After receiving the updates, the pool of property sales is recalculated and the map image automatically updates to provide the revised showing of property sales. In one embodiment, a third indicator is used to illustrate those properties that have been removed from the current set of property sales.

A current pool of properties can be referred to as a sub-market for the corresponding subject property. According to another aspect of this disclosure, graphical depictions of property characteristics distributions for updatable sub-markets are provided. There, the map image depicts the subject property and corresponding included properties in the currently defined (e.g., filtered according to the current set of property characteristic ranges) sub-market. Various property characteristics distribution information for the current sub-market may be concurrently displayed alongside the map image. In one example, the number of instances of properties is plotted against respective values for a given property characteristic. Additionally, graphical indications of the number of instances as represented in a general market alongside the current sub-market are provided. This allows the reviewer to readily observe how and whether the distribution of the sub-market differs from the corresponding distribution in the general market.

In addition to the map image, a detailed listing of the property characteristics for the subject property and the current pool of property sales is displayed. From either the map image or the detailed listing, an individual property may be selected for inclusion within or exclusion from a sub-market. Graphical indicators are provided to depict whether a given property is in a current sub-market, and these may be used to trigger a process to individually include or exclude the given property. User interfaces for receiving and storing custom information in association with an include/exclude process are provided. Additionally, a special indicator illustrates that a given property had been individually included within a sub-market. This allows a highlighting of properties that were “custom” introduced to the sub-market as well as the opportunity to review specified reasoning that the given property was included (or, by contrast, excluded) from any sub-market under review.

The property characteristics in the detailed listing provided alongside the map image may include an automated valuation for the subject property based upon a current sub-market defined to include the current pool of property sales. When an update of the pool is generated as a result of changes to the ranges of property characteristics, the valuation automatically updates according to the newly defined sub-market, along with an automatic update to the map image to distinctively show the subject property, the excluded properties, and the property sales remaining in the newly defined sub-market. This allows the user to readily review the impact of a variety of alterations of the property characteristics upon the generated valuation, both in terms of reviewing the map image and the corresponding property locations, as well as the corresponding valuation and other data. Along with this, each property may be selected for review and assessment as to the underlying data and other characteristics to further evaluate whether the property is a good comparable, and also whether the characteristics associated with that property are accurate and complete. All of these features help the user to assess and update the quality of the pool of potential comparables for the subject property. Still further, the user can review the map image and corresponding inclusion and exclusion of potential comparable properties. For example, the map image may readily show a property that is very close to the subject property (e.g., next door) that has been excluded in a filtering operation. That property can be reviewed (e.g., perhaps there is a data error in its characteristics) and if desired it can be re-introduced to the pool individually by the user.

Preferably, an automated valuation model is used to provide valuations for properties in the pool of potential comparable properties, including the contributions of characteristics to those valuations. The AVM provides an initial point of reference that allows the user to identify data errors and other reasons that a property may or may not be included in a currently filtered pool of properties. Various models may be implemented. In one example, the property data is accessed and a regression models the relationship between price and explanatory variables. For example, a hedonic regression is performed at a geographic level (e.g., county) sufficient to produce reliable results.

An initial determination (i.e., the starting point for a user's review) of a pool of recent sales may employ no exclusion rules. For example, in one embodiment the general market (which may also be referred to as a default pool) may comprise a predetermined number of properties (e.g., 500) having sales data within a given period of time (e.g., one year) that are closest to the subject property in terms of physical distance. However, if desired, various default characteristics may be applied for the purpose of generating an initial pool of recent sales as potential comparables, such as by initial exclusion rules based upon factors other than distance from the subject property.

The described AVM preferably determines value contributions for the respective variables that cumulatively produce a valuation for any analyzed property. The AVM may also be used to quantify the similarity of properties to the subject property, and that quantification may also be used to rank or weight comparable properties.

In connection with the display of listings of comparables, a map image is displayed to illustrate the geographic distribution of the subject property and the property sales. Thus, in addition to offering the ranked listing that indicates where among the ranking the comparables are listed, there is a concurrent display on the map image that gives an immediate indication of the location of the property sales. This allows further assessment as to general proximity between the comparables and the subject property, whether the comparables are in the same or a different neighborhood, and where the comparables are located with respect to significant features (highways, schools, bodies of water, etc.), etc.

An associated property data grid further details information about the subject and property sales. The grid operates in conjunction with the map image to ease review of the comparables and corresponding criteria. The map image may be variously scaled and updates to show the subject property and corresponding comparables in the viewed range, and interacts with the grid (e.g. cursor overlay on comparable property in the map image allows highlighting of additional data in the grid).

Various models may be used to generate automated valuations based upon updatable pools of property sales, including but not limited to one using a hedonic regression technique.

One example of a hedonic equation is described below. In the hedonic equation, the dependent variable is sale price and the explanatory variables can include the physical characteristics, such as gross living area, lot size, age, number of bedrooms and or bathrooms, as well as location specific effects, time of sale specific effects, property condition effect (or a proxy thereof). This is merely an example of one possible hedonic model. The ordinarily skilled artisan will readily recognize that various different variables may be used in conjunction with the present invention.

In this example, the dependent variable is the logged sale price. Examples of the explanatory variables include:

(1) Continuous property characteristics, such as:

(a) log of gross living area (GLA),

(b) log of Lot Size,

(c) log of Age, and

(d) Number of Bathrooms; and

(2) And fixed effect variables, such as:

(a) location fixed effect (e.g., by Census Block Group (CBG));

(b) Time fixed effect (e.g., measured by 3-month periods (quarters) counting back from the estimation date); and

(c) Foreclosure status fixed effect, which captures the maintenance condition and possible REO discount.

This disclosure is not limited to the above-described variables. For example, additional variables for condition, quality, view, location, waterfront, parking places, and floor (if condo) are preferably provided in some embodiments.

A format for an exemplary equation (Eq. 1) is as follows:

$$ln ( p ) = {β}_{gla} \cdot ln ( GLA ) + {β}_{lot} \cdot ln ( LOT ) + {β}_{age} ln ( AGE ) + {β}_{bath} \cdot BATH + {\sum }_{i = 1}^{{N}_{CBG}} {LOC}_{i}^{CBG} + {\sum }_{j = 1}^{{N}_{QTR}} {TIME}_{j} + {\sum }_{k = \{ 0 , 1 \}}^{ } {FCL}_{k} + ɛ \qquad ( Eq . 1 )$$

The above equation is offered as an example, and as noted, there may be other variables or alterations of the delineation of the variables. For example, although CBG is used as the location fixed effect, other examples may include Census Tract or other units of geographical area. Additionally, months may be used in lieu of quarters, or other periods may be used regarding the time fixed effect. These and other variations may be used for the explanatory variables.

Additionally, although the county may be used for the relatively large geographic area for which the regression analysis is performed, other areas such as a multi-county area, state, metropolitan statistical area, or others may be used. Still further, some hedonic models may omit or add different explanatory variables.

As introduced above, a basic default set of comparables may implement little or no exclusion rules. However, as described further below, user interfaces are provided to filter property characteristics pursuant to an automatic update of a default pool (i.e., default sub-market) in order to create and render an updated pool (i.e., updated sub-market). Comparable selection rules are used to narrow or expand the pool of comps according to the filter characteristics.

Given the (default or updated) pool of comps, the sale price of each comp may then be adjusted to reflect the difference between a given comp and the subject in each of the characteristics used in the hedonic price equation.

For example, individual adjustments are given by the following set of equations (2):

A_{gla}=exp└(ln(GLA_{S})−ln(GLA_{C}))·β_{gla}┘;

Aₗₒₜ=exp└(ln(LOT_{S})−ln(LOT_{C}))·βₗₒₜ┘;

A_{age}=exp└(ln(AGE_{S})−ln(AGE_{C}))·β_{age}┘;

A_{bath}=exp└(BATH_{S}−BATH_{C})·β_{age}┘;

A_{loc}=exp[LOC_{S}−LOC_{C}];

Aₜᵢₘₑ=exp[TIME_{S}−TIME_{C}]; and

A_{fcl}=exp[FCL_{S}−FCL_{C}], (Eq. 2)

where coefficients βgla, βlot, βage, βbath, LOC, TIME, FCL are obtained from the hedonic price equation described above. Hence, the adjusted price of the comparable sales is summarized as:

$${p}_{C}^{adj} = {p}_{C} \cdot {\prod }_{i ∈ \{ gla , lot , age , bath , loc , time , fcl \}}^{ } {A}_{i} = {p}_{C} \cdot {A}_{TOTAL} \qquad ( Eq . 3 )$$

Because of unknown neighborhood boundaries and potentially missing data, the initial pool of potential comparables will likely include more than are necessary for the best value prediction in most markets. The adjustments described above can be quite large given the differences between the subject property and potential comparable properties. Accordingly, rank ordering and weighting are also useful for the purpose of value prediction, and as one of the tools provided to the user in support of creating more well defined sub-markets for the subject property.

One example of information that may be used to rank the comparables is referred to as economic distance. The economic distance D_{eco} between the subject property and a given comp may be described as a function of the differences between them as measured in dollar value for a variety of characteristics, taking into account the property characteristics as well as other criteria such as the adjustment factors described above.

Specifically, the economic distance may be defined as a Euclidean norm of individual percent adjustments for all characteristics used in the hedonic equation:

$${D}_{SC}^{eco} = \sqrt{{\sum }_{i ∈ \{ gla , lot , age , bath , loc , time , fcl \}} {( {A}_{i} - 1 )}^{2}} \qquad ( Eq . 4 )$$

The comps can be weighted using this information. Properties more similar to the subject in terms of physical characteristics, location, and time of sale are presumed better comparables and thus are preferably accorded more weight in the prediction of the subject property value. Accordingly, the weight of a comp may be defined as a function inversely proportional to the economic distance, geographic distance and the age of sale.

For example, comp weight may be defined as:

$${w}_{C} = \frac{1}{{D}_{SC}^{eco} \cdot {D}_{SC}^{geo} \cdot {dT}_{SC}} \qquad ( Eq . 5 )$$

where D_{geo} is a measure of a geographic distance between the comp and the subject, defined as a piece-wise function:

$${D}_{SC}^{geo} = \{ \begin{matrix}0.1 & if {d}_{SC} < 0.1 mi \\ {d}_{SC} & if 0.1 mi \leq {d}_{SC} \leq 1.0 mi \\ 1.0 + \sqrt{{d}_{SC} - 1.0} & if {d}_{SC} > 1.0 mi\end{matrix} , \qquad ( Eq . 6 )$$

and dT is a down-weighting age of comp sale factor

$${dT}_{SC} = \{ \begin{matrix}1.00 & if ( 0 , 9 ] days \\ 1.25 & if ( 90 , 180 ] days \\ 2.00 & if ( 180 , 270 ] days \\ 2.50 & if ( 270 , 365 ] days\end{matrix} . \qquad ( Eq . 7 )$$

Comps with higher weight receive higher rank and consequently contribute more value to the final prediction, since the predicted value of the subject property based on comparable sales model is given by the weighted average of the adjusted price of all comps:

$${\hat{p}}_{S} = \frac{{\sum }_{C = 1}^{{N}_{COMPS}} {w}_{C} \cdot {p}_{C}^{adj}}{{\sum }_{C = 1}^{{N}_{COMPS}} {w}_{C}} \qquad ( Eq . 8 )$$

As can be seen from the above, the separate weighting following the determination of the adjustment factors allows added flexibility in prescribing what constitutes a good comparable property. Thus, for example, policy factors such as those for age of sale data or location may be separately instituted in the weighting process. Although one example is illustrated it should be understood that the artisan will be free to design the weighting and other factors as necessary.

Optionally, the potential comparable properties may then be listed according to the weighting, or a ranking from the highest weighted comparable property to the lowest. This listing may be variously limited to accommodate listing them within a display area.

Mapping and analytical tools that implement the comparable model are provided. Mapping features allow the subject property and recent sales/potential comparable properties to be concurrently displayed, along with the grid of property data.

With further reference to the figures, examples of environments and particular embodiments implementing the generation of pools of property sales are now further described.

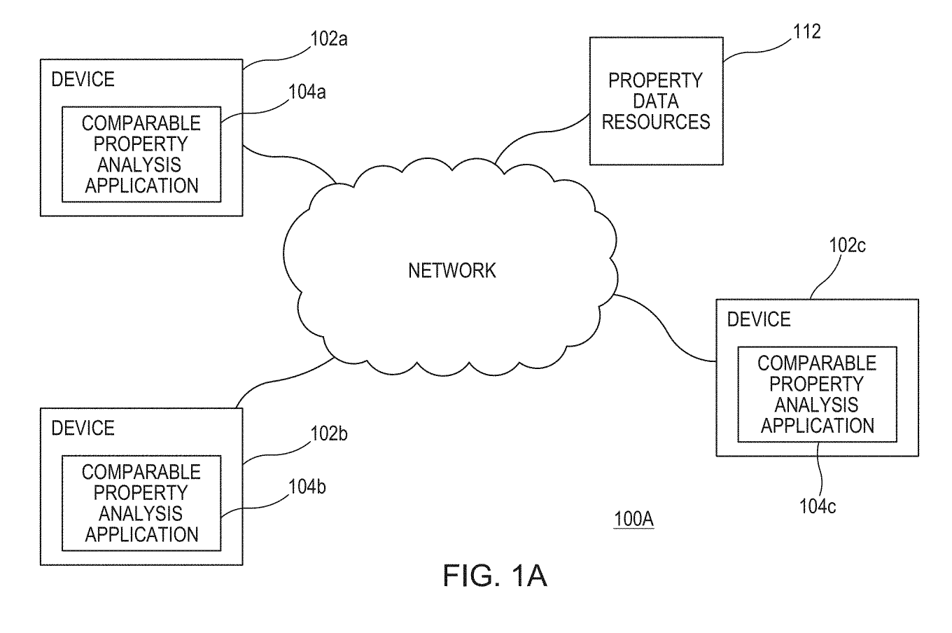

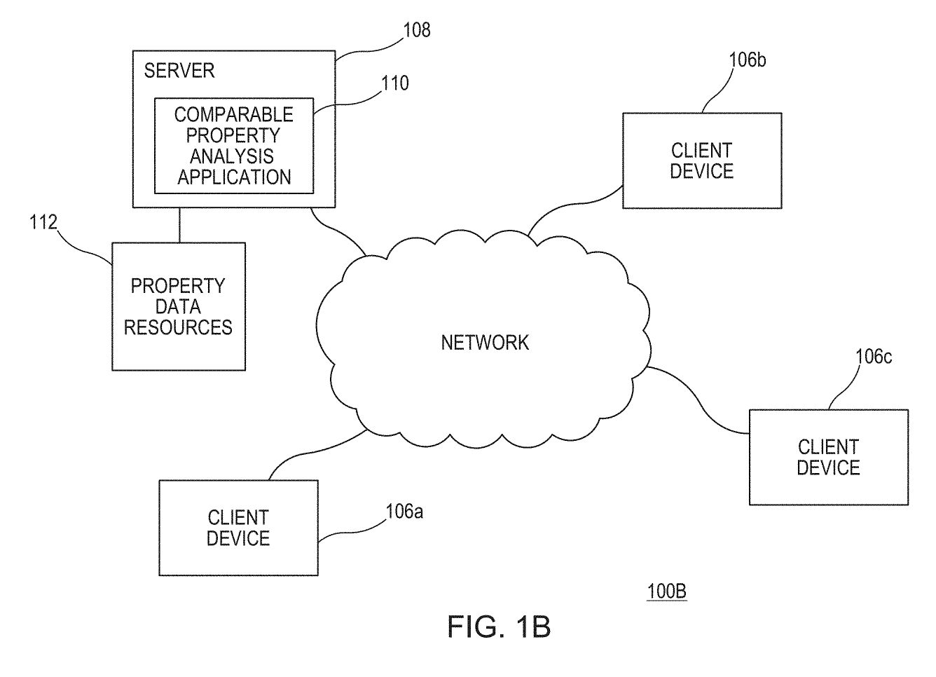

FIGS. 1A-B are block diagrams illustrating examples of systems 100A-B in which a comparable property analysis application operates.

FIG. 1A illustrates several user devices 102a-c each having a comparable property analysis application 104a-c.

The user devices 102a-d are preferably computer devices, which may be referred to as workstations, although they may be any conventional computing device. The network over which the devices 102a-d may communicate may also implement any conventional technology, including but not limited to cellular, WiFi, WLAN, LAN, or combinations thereof.

In one embodiment, the comparable property analysis application 104a-c is an application that is installed on the user device 102a-c. For example, the user device 102a-c may be configured with a web browser application, with the application configured to run in the context of the functionality of the browser application. This configuration may also implement a network architecture wherein the comparable property analysis applications 104a-c provide, share and rely upon the comparable property analysis application 104a-c functionality.

As an alternative, as illustrated in FIG. 1B, the computing devices 106a-c may respectively access a server 108, such as through conventional web browsing, with the server 108 providing the comparable property analysis application 110 for access by the client computing devices 106a-c. As another alternative, the functionality may be divided between the computing devices and server. Finally, of course, a single computing device may be independent configured to include the comparable property analysis application.

As illustrated in FIGS. 1A-B, property data resources 110 are typically accessed externally for use by the comparable property analysis application, since the amount of property data is rather voluminous, and since the application is configured to allow access to any county or local area in a very large geographical area (e.g., for an entire country such as the United States). Additionally, the property data resources 110 are shown as a singular block in the figure, but it should be understood that a variety of resources, including company-internal collected information (e.g., as collected by Fannie Mae), as well as external resources, whether resources where property data is typically found (e.g., MLS, tax, etc.), or resources compiled by an information services provider (e.g., Lexis).

The comparable property analysis application accesses and retrieves the property data from these resources in support of the modeling of comparable properties as well as the rendering of map images of subject properties and corresponding property sales, and the display of supportive data (e.g., in grid form) in association with the map images.

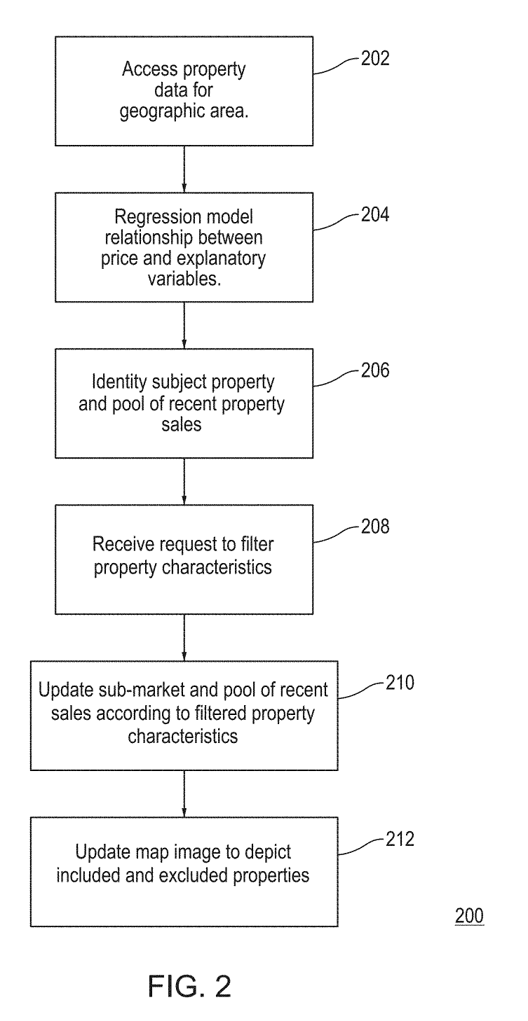

FIG. 2 is a flow diagram illustrating an example of a process 200 for updating a pool of property sales/potential comparable properties.

As has been described, the application accesses 202 property data. This is preferably tailored at an initial geographical area of interest in which a subject property is located (e.g., county). A regression 204 modeling the relationship between price and explanatory variables is performed on the accessed property data. Although various alternatives may be applied, a preferred regression is that described above, wherein the explanatory variables are the property characteristics (GLA, lot size, age, number of bathrooms) as well as the categorical fixed effects (location, time, foreclosure status).

A subject property within the county is identified 206 as is a pool of recent sales as potential comparable properties. As described, the subject property may be initially identified, which dictates the selection and access to the appropriate county level data. Alternatively, a user may be reviewing several subject properties within a county, in which case the county data will have been accessed, and new selections of subject properties prompt new determinations of the pool of property sales for each particular subject property.

Typically, the closest properties (in physical distance) to the subject property define an initial pool of property sales that are potential comparables, such as the closest 500 properties. But the pool of property sales may be initially defined using some default exclusion rules, if desired.

Valuation may be carried out using adjustment factors for each comparable property. The adjustment factors may be a numerical representation of the price contribution of each of the explanatory variables, as determined from the difference between the subject property and the comparable property for a given explanatory variable. An example of the equations for determining these individual adjustments has been provided above. The listing of property sales can also be conveyed to the user in the form of grid and map image displays to allow convenient and comprehensive review and analysis of the set of comparables.

The application also includes interfaces for filtering property characteristics, and corresponding updates to the pool of property sales. This entails initially receiving 208 a request to filter the property characteristics that are used to include/exclude comparables from the pool. This request is preferably initiated by receipt of user input such as through a button that prompts display of a filtering interface having a list of property characteristics and corresponding updatable ranges. Updates to the ranges for various property characteristics can be applied through the interface, and once a user is satisfied with a new set of ranges, the user may submit the new ranges.

Upon receipt of this submission, the application updates 210 the corresponding pool of recent sales to be included in a sub-market analysis) according to the filtered property characteristics data. This entails the application of exclusion rules and an updating of the pool. Additionally, adjustments and valuations of the subject property and updated pool of potential comparables is performed.

With the updated information, the application updates 212 the display to alter the map image, as well as the listing of comparables. Preferably, the pool of property sales is indicated uniquely via an indicator such as a solid dot, to depict that they are within the current pool. Those property sales that were in a default set, but which were removed as a result of the filtering, may be indicated in alternative fashion, such as by a clear triangle. In this fashion, the user is given an indication of the reduction in the pool as a result of the filtering operation. Additionally, the listing of properties may be provided on the same display, along with any valuation updates resulting from the change in sub-market caused by the filtering.

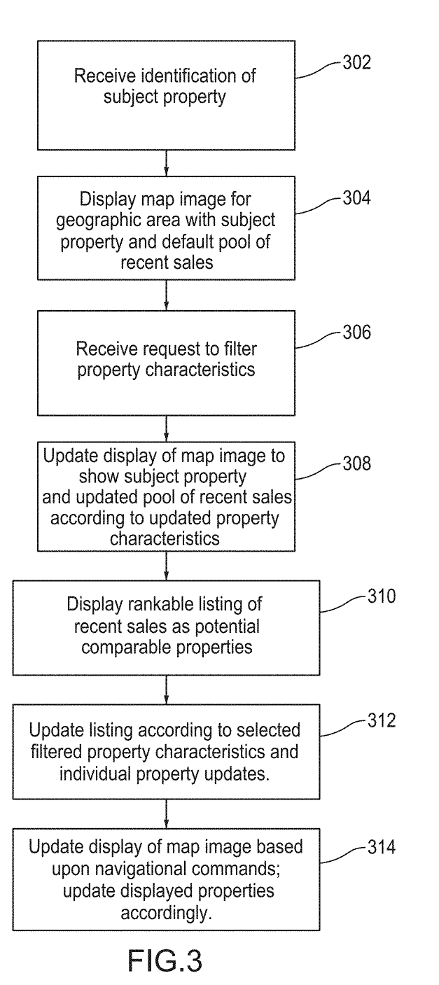

FIG. 3 is a flow diagram illustrating an example of a method 300 for displaying property sales, including updated valuation of property sales based upon newly defined sub-markets.

The method 300 may initiate with identification 302 of a subject property. This may be performed using a user interface that allows a user to input property identification information as a starting point to preparing an appraisal. Once the subject property is identified, the subject property and a corresponding default pool of recent sales as potential comparables may be displayed 304 on a map image with indicators showing the subject property and the locations of the recent sales. This map image may be acquired from conventional mapping resources, including but not limited to Google maps and the like. Additionally, conventional techniques may be used to depict subject and property sales on the map image, such as through determination of the coordinates from address information.

The map imagery may be updated to provide user-desired views, including zooming in and out to provide more narrow or broad perspectives of the depictions of the comparable and subject properties. In addition to the map image, a corresponding grid of comparative property data concerning the listed properties may be concurrently displayed.

The property data includes information as to the location of the properties, and either this native data may be used, or it may be supplemented, to acquire the exact location of the subject property and potential comparable properties on the map image. This allows the map image to be populated with indicators that display the location of the subject property and the potential comparable properties in visually distinguishable fashion on the map image. The number of property sales that are shown can be predetermined or may be configurable based upon user preferences. The number of property sales that are shown may also update depending upon the level of granularity of the map image. That is, when the user updates the map image such as by zooming out to encompass a wider geographical area, the map image automatically updates to depict additional property sales over those rendered at a more local range.

The user may also prompt a particular comparable property to be highlighted, such as by cursor rollover or selection of an entry for the comparable property in a listing. When the application receives an indication that a property has been selected, it is highlighted in the map. Conversely, the user may also select the indicator for a property on the map image, which causes display of the details corresponding to the selected property.

Once the default pool of potential comparables is provided, it may be updated according to various criteria. This may be initiated by a receiving 306 a request to filter property characteristics that are used to define a sub-market for the subject property. The initial set of property characteristics are set based upon the characteristics of the subject property, with default ranges defining included and excluded properties. An initial set of ranges provides relatively coarse filtering so as to include a reasonably large initial pool of potential comparables. User interfaces are provided to allow the user to change the ranges for the property characteristics. In one example, once the user is satisfied with a new set of property characteristics, a submit button or the like prompts an updated display 308 of the map image to show the subject property and an update to the current pool of recent sales/potential comparables according to the updated (filtered) property characteristics. The corresponding display 310 of underlying property characteristics for the property sales, as updated by the filtering of property characteristics, also automatically occurs at this time.

The AVM as described above works in conjunction with the updatable set of property characteristics in order to provide updates to at least some variables associates with the corresponding updatable pools of property sales. In one example, the model may be the described hedonic regression performed initially at a geographic level (e.g., county or CBG) sufficient to produce reliable results. As set forth in further detail above, the described model identifies a pool of potential comparables, determines adjustments for each comparable using adjustment factors drawn from the regression analysis, derives an economic distance between each comparable and the subject property, and can weigh the comparables according to the economic distance between the comparable and the subject property. This weighting can be used to determine a ranked listing, with the highest weighting being the closest-ranked comparable, and so on. However, the grid of property data may be variously manipulated by the user to provide alternative “rankings”. For example, the user might simply want to rank the properties on physical distance, or perhaps a characteristic like the number of bedrooms. The interface automatically updates the listing of properties so the user may freely assess the pool of property sales according to any desired criteria. At the same time, the AVM automatically updates its model-based valuation of the comparables.

Although the particulars of one model are described herein, it should be understood that alternative models may be implemented according to the present invention.

Still further, the ranked listing is updated 312 upon the receipt of changes to the filtered property characteristics. When this operation occurs, both the map image and the ranked listing are updated to display a new pool of property sales. Moreover, a new valuation for the subject property is indicated based upon the new pool of property sales. Additionally, the map image may be further updated to assess geographical areas at various levels of granularity (e.g., zoom in upon the neighborhood of the subject property, or zoom out to review potential comparable properties for a broader geographical area). The map image updates 314 accordingly, both as to the map image and the inclusion of indicators for the subject and property sales. Still further, any individual property may be reviewed and updated, including an operation to bring an individual property from excluded status into the current pool of recent sales for further consideration as a comparable. All updates to the individual property are tracked to allow subsequent analysis of the reasoning for changes and inclusion or exclusion from the pool of recent sales or as a comparable property. Additionally, the AVM provides valuation information useful for flagging potential data errors. A user may select any individual property and drill down as to the reasoning for individual property valuation. Odd results may prompt inspection and allow the identification of errors in the property data.

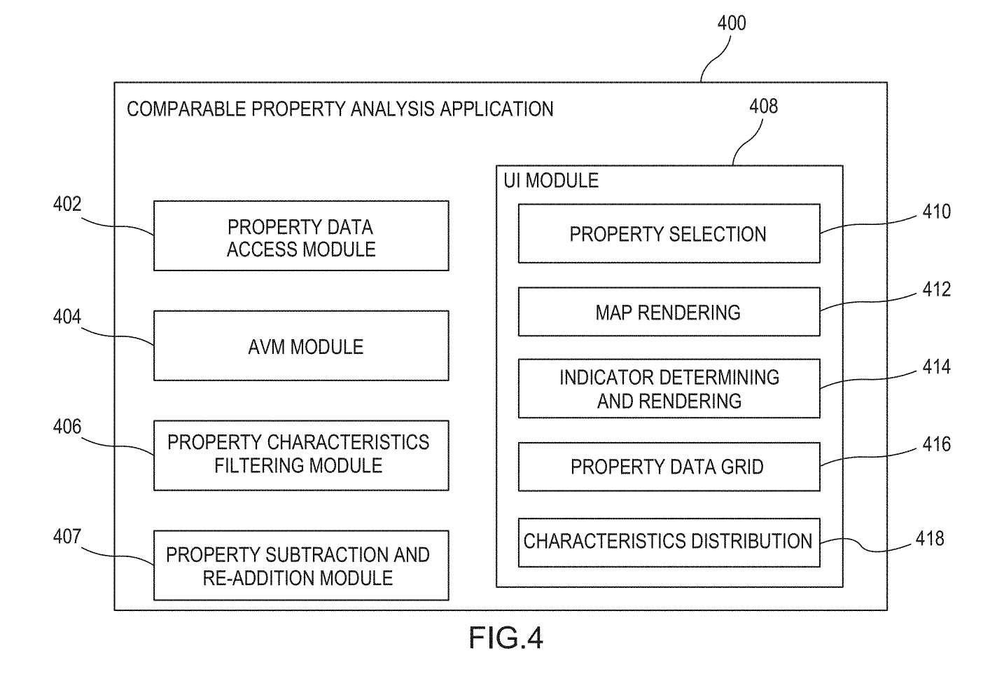

FIG. 4 is a block diagram illustrating an example of a comparable property analysis application 400. The application 400 preferably comprises program code that is stored on a computer readable medium (e.g., compact disk, hard disk, etc.) and that is executable by a processor to perform operations in support of the operations described herein, including property data access and corresponding identification of subject properties, modeling and valuation, rendering map and graphical images, and receiving and responding to corresponding user input as described further below.

According to one aspect, the application includes program code executable to perform operations of receiving an identification of a subject property; displaying a map image including a geographical area in which the subject property resides, the subject property being displayed within the geographical area using a first graphical indicator; displaying a first set of property sales within the geographical area using a second graphical indicator that is distinct from the first graphical indicator; receiving a request to filter the first set of property sales; responsive to receiving the request, concurrently displaying a listing of property characteristics alongside the map image, the listing of property characteristics being configured to receive changes in ranges corresponding to the property characteristics; receiving an altered range for at least one of the property characteristics from the listing of property characteristics; and automatically updating the map image to display a second set of property sales that differs from the first set of property sales in response to receiving the altered range.

The application is also configured such that the second set of property sales can be displayed using the second graphical indicator, and those of the first set of property sales that are not included in the second set of property sales are displayed using a third graphical indicator.

Still further, the application is configured to automatically update an automated valuation for a subject property when the corresponding pool of property sales is updated according to the filtering criteria.

Still further, the application is configured to determine property characteristics distribution information and to display graphical images indicating the distribution information. The distribution information may include depictions of property characteristics against price, with indicators for properties within general and sub-markets. Also, the distribution information may include depictions of the number of instances for respective values of properties characteristics, again for both general and sub-markets.

The comparable property analysis application 400 is preferably provided as software, but may alternatively be provided as hardware or firmware, or any combination of software, hardware and/or firmware. The application 400 is configured to provide the comparable property modeling, appraisal results comparing and corresponding mapping functionality described herein. Although one modular breakdown of the application 400 is offered, it should be understood that the same functionality may be provided using fewer, greater or differently named modules.

The example of the comparable property analysis application 400 of FIG. 4 includes a property data access module 402, an AVM module 404, a property characteristics filtering module 406, a property subtraction and re-addition module 407, and a UI module 408. The UI module 408 further includes property selection 410, map rendering 412, indicator determining and rendering 414, property data grid 416 and characteristics distribution 418 modules.

The property data access module 402 includes program code for carrying access and management of the property data, whether from internal or external resources. The AVM module 404 includes program code for carrying out the regression upon the accessed property data, according to the regression algorithm described above, and produces corresponding results such as the determination of regression coefficients and other data at the country (or other) level as appropriate for a subject property. The AVM module 404 also implements program code for carrying out the regression given the described explanatory variables and property data.

The property characteristics filtering module 406 is configured to apply default ranges for an initial pool of property sales. If desired, some exclusion rules may be applied to determine the initial pool of property sales. It is also configured to receive input with respect to updated ranges of property characteristics, so as to provide updates to the pool upon application of the new ranges. It is in communication with the UI module 408 so as to receive input with respect to the property characteristic ranges, and to provide updates in support of updated interfaces displayed by the UI module 408.

The property subtraction and re-addition module 407 provides user interfaces that allow the user to individually choose properties for inclusion within or exclusion from a sub-market. The interfaces also allow receipt and retention of customized input for explanations of the reasoning behind an exclusion or inclusion within a sub-market. The property subtraction and re-addition module 407 is in communication with the property characteristics filtering module 406 so that a sub-market may be appropriately tailored for appropriate definition and display as described in connection with the UI module 408.

Appraisal information may also be accessed or generated using the application. The appraisal information is typically in the form of appraisal reports for subject properties, wherein a set of comparable properties chosen by an appraiser is listed. For example, when using this application, appraisal activities of the user may be recorded so that they may be subsequently retrieved. The appraisal information may be retrieved based upon a variety of criteria, including search by subject property, identification number, or characteristics (appraiser ID, vendor, date, etc.).

The UI module 408 manages the display and receipt of information to provide the described functionality. It includes a property selection module 410, to manage the interfaces and input used to identify one or more subject properties and corresponding appraisal information. The map rendering module 412 accesses mapping functions and manages the depiction of the map images as well as the indicators of the subject property, properties included in a sub-market, properties excluded from a sub-market, and properties individually included within or excluded from a sub-market. The indicator determination and rendering module 414 is configured to manage which indicators should be indicated on the map image depending upon the current map image, the corresponding default market, filtering to define a sub-market, and individualized include/exclude input. The property data grid module 416 manages the data set corresponding to a current session, including the subject property and pool of property sales. It is configured as a database that allows the property data for the properties to be displayed in a tabular or grid format, with various sorting according to the property characteristics, economic distance, geographical distance, time, etc.

The characteristics distribution module 418 includes program code for organizing property characteristics data for general markets and updateable sub-markets for subject properties. In one aspect, it includes records corresponding to the property data grid database. The property characteristics may, for example, include GLA, Beds, Baths, Age, Basement Total, Basement Finished, Quality, Condition and Lot Size information corresponding to a market and one or more sub-markets for a subject property. The characteristics distribution module 418 accesses this information in support of the rendering of graphical images that depict property characteristics distribution. The graphical images include a plot of any given one of the characteristics against price, with point plotting for the market and sub-market, and corresponding interpolation and plotting of functions depicting the relationship for the market and submarket. The graphical images also include a comparison of the number of instances for respective values of any given property characteristic, with bar graph indication of respective numbers of instances for such values for both the general market and a current sub-market for a subject property.

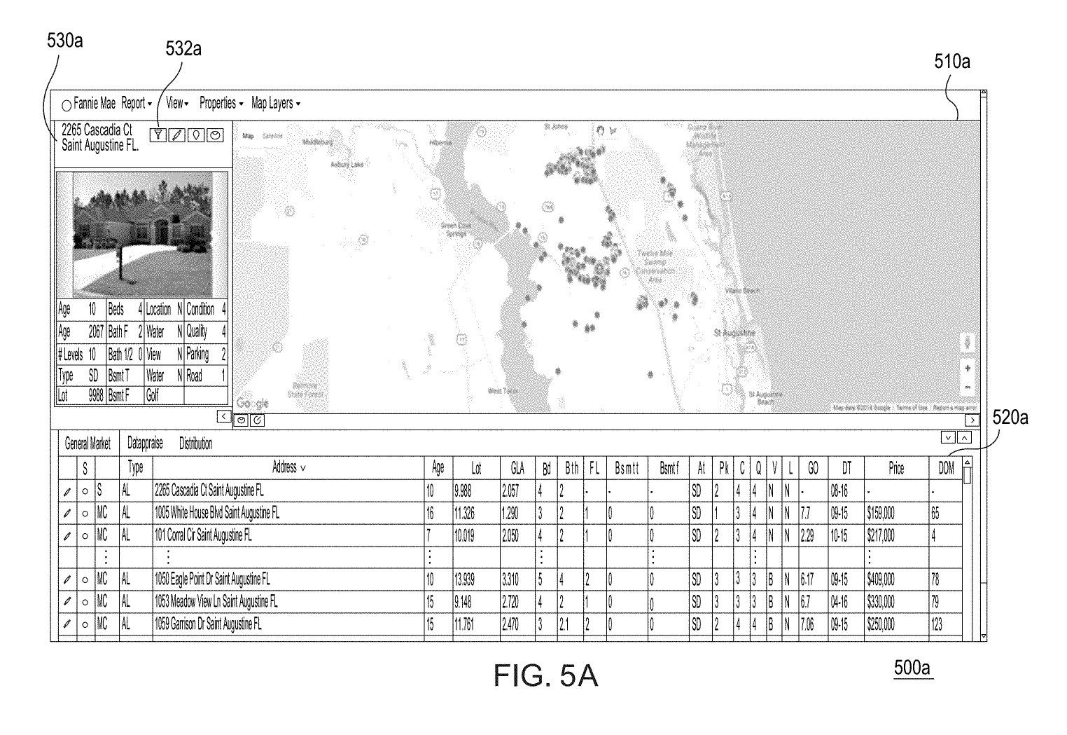

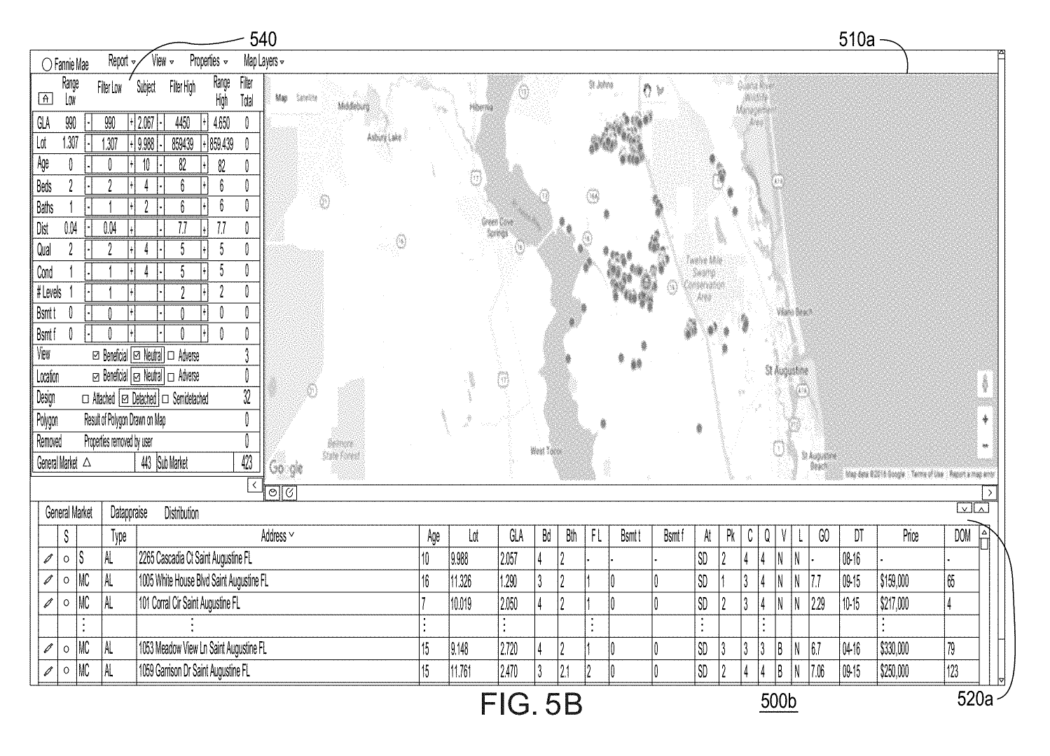

FIG. 5A is a display diagram 500a illustrating an example of a map image 510a and corresponding property grid data 520a for a list of property sales. The display diagram 500a also includes a region 530a depicting a currently selected subject property.

The property grid data 520a contains a listing of details about the subject property and the potential comparable properties, as well as various information fields. The fields include the address of the property (“Address”), the square footage (“GLA”), the lot size (“Lot”), the age of the property (“Age”), the number of bathrooms (“Bath”), the date of the prior sale (“Sale Age”), the prior sale amount (“Price”), and other information.

The list of potential comparable properties 520a, at least at the outset, is according to default property characteristics for defining the pool of property sales. In the subject property region 530a, a show-filters button 532a is preferably provided, which prompts the activation of the mode for updating the property characteristics that are used to define the pool of potential comparables.

FIG. 5B is an updated display 500b following the selection of the show-filters button 532a. The subject property region 530a is removed in favor of a listing of property characteristics 540 with corresponding ranges. For example, the property characteristics include GLA, Lot Size, Age, Bedrooms, Bathrooms, Distance, Quality Rating, Condition rating, Number of Levels, Basement Finished, and Basement Total. The user is also provided Low and High Range, the Subject Property's characteristics, and a Filter High and Filter Low, and filter total columns. The user can then use the Filter Low and Filter High Columns for each characteristic to adjust the shown recent sales based upon the changed characteristics.

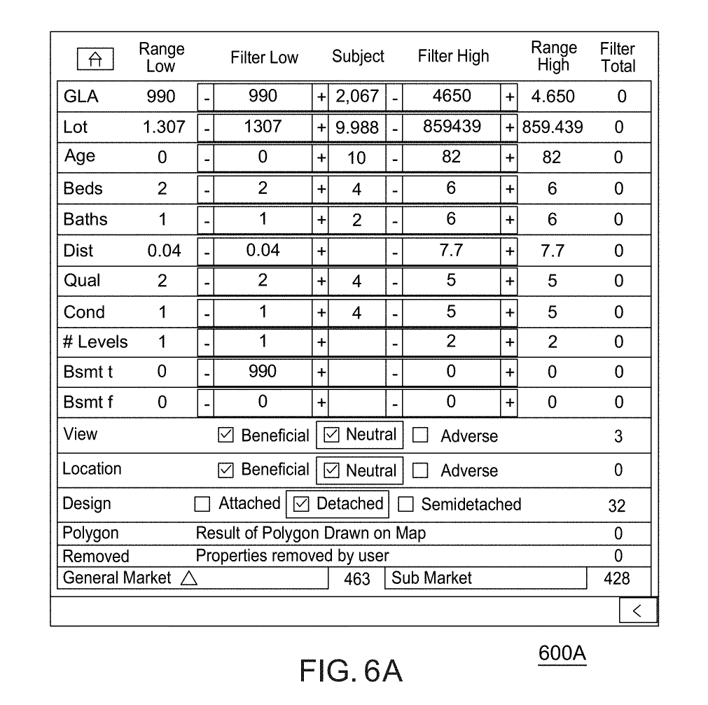

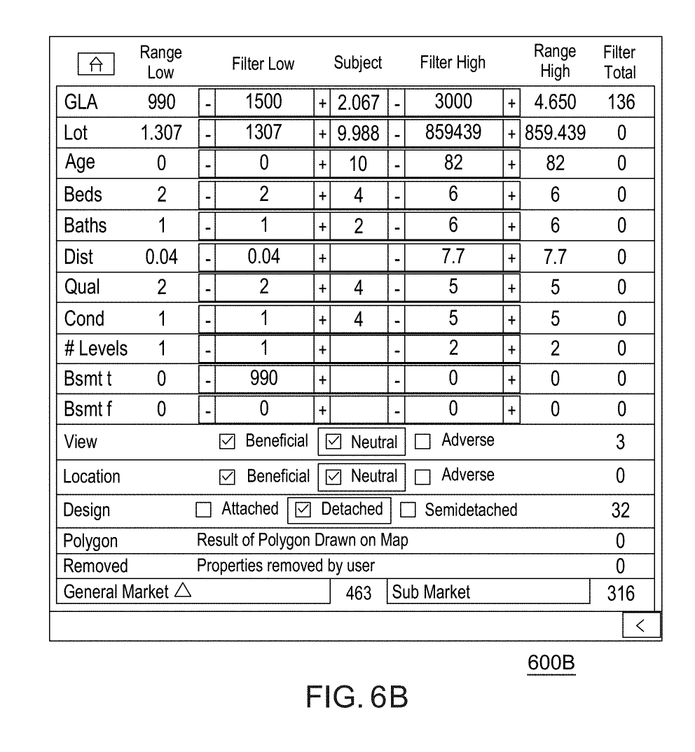

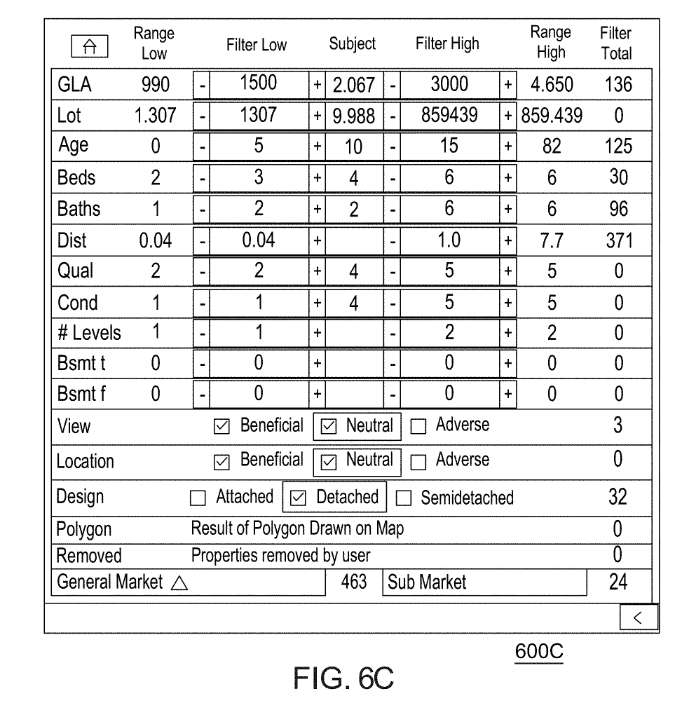

FIGS. 6A-C illustrate examples of the property characteristics filtering interface 600a-c. For example, FIG. 6A illustrates the interface 600a before using the filter low and high columns. The lower right corner of the interface 600a depicts the number of property sales in the pool according to the current settings. Here, 428 properties are in the pool of recent sales (“sub-market”). FIG. 6B illustrates the interface 600b after it has been updated to change the GLA range. Specifically, in FIG. 6A, the GLA range extends from 990 SF through 4650 SF, whereas the subject property is 2,067 SF. In FIG. 6B, the GLA range is changed from a filter low number of 1500 to a filter high number of 3000. The Sub Market is then indicated as 316 properties. FIG. 6C illustrates the interface 600c where the ranges for additional characteristics, namely age, number of bedrooms, number of bathrooms and distance from the subject property are updated. As illustrated, the number of properties in the sub-market at that point reduces to a 24 properties. In this fashion, the user is provided with a graphical indication of the market, along with depictions of the properties on the map image, and real time updates to the available pool of recent sales as the filters are manipulated.

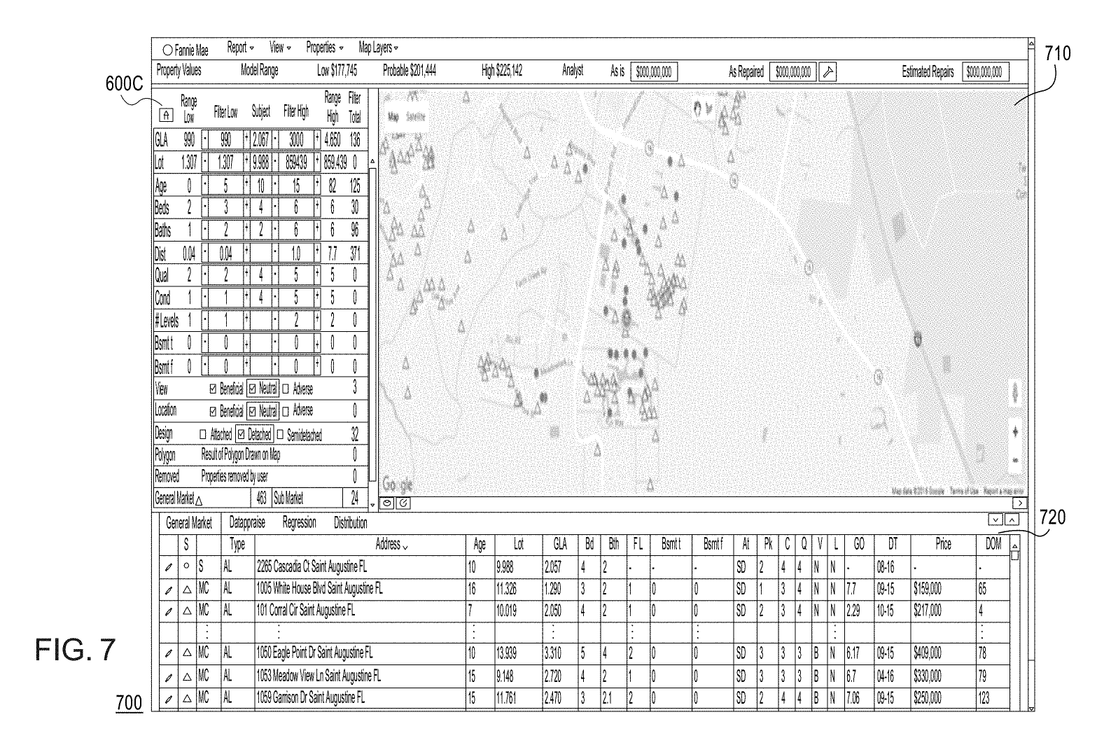

FIG. 7 is a display diagram having an updated display 700 following manipulation of the filters, particularly how the updated display 700 appears according to the filtering as shown in the interface 600c. The map image 700 automatically updates to depict the pool of recent sales that are included as solid dots, and those that are excluded as clear triangles. Additionally, the property grid data 720 updates to include only the included pool of recent sales. In this fashion, the user receives a clear depiction of the included properties alongside the more limited amount of comparables and their corresponding property data.

The map images depict geographical areas that can be manipulated to show a larger or smaller area, or moved to shift the center of the map image, in convention fashion. This allows the user to review the location of the subject property and corresponding comps at any desired level of granularity. This map image may be separately viewed on a full screen, or may be illustrated alongside the property data grid as shown.

Further assessment of the data can be variously undertaken by the user. The map image also allows the user to place a cursor over any of the illustrated properties to prompt highlighting of information for that property and other information. Additionally, the listing of comparables in the property grid data can be updated according to any of the listed columns. The grid data can be variously sorted to allow the user to review how the subject property compares to the listed potential comparable properties.

The user may variously update the map image and manipulate the property data grid in order to review and assess and subject property and the corresponding comparable properties in a fashion that is both flexible and comprehensive.

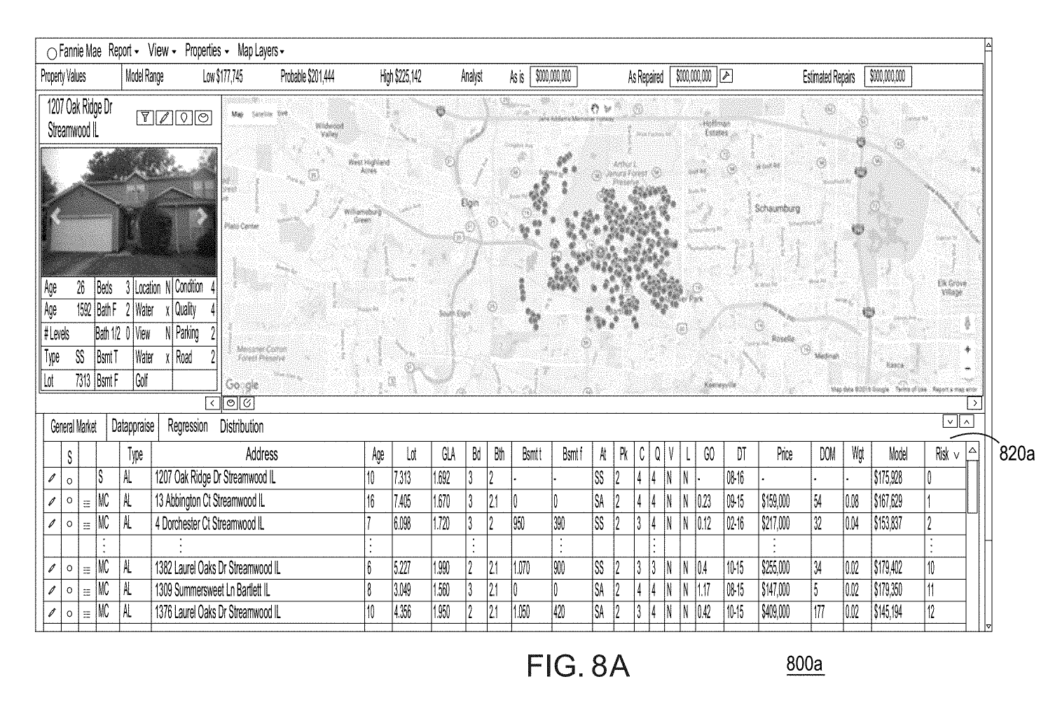

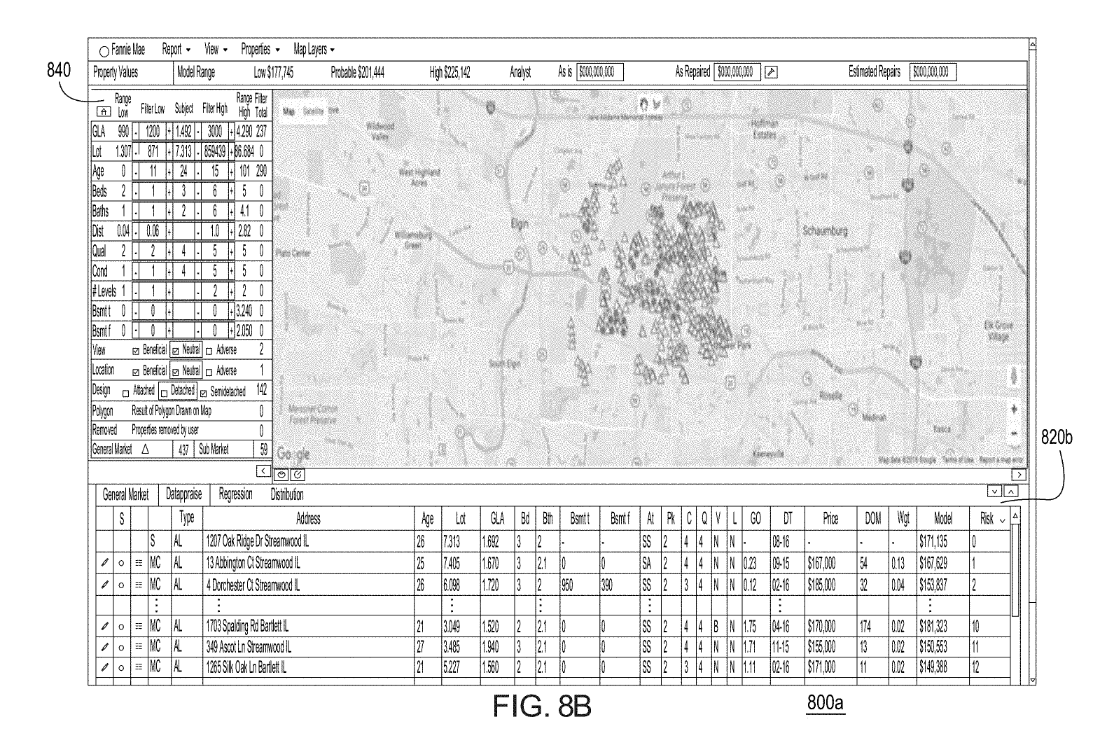

FIGS. 8A-B illustrate how the automated valuation of the subject property (i.e., the value determined by the model) updates when there are changes in the sub-market as a result of the property characteristics filtering operation. For example, FIG. 8A depicts a display 800a that includes a model-based valuation of $175,928 for the subject property in the property grid data 820a, under the default conditions (e.g., including all recent sales in the geographical area). FIG. 8B depicts the display 800b updated following application of filtering. As evident from the filtering interface 840, a submarket is created using homes with a GLA between 1,200 and 2,300 SF, an age between 18 and 35 years, and other filtered characteristics. The resulting sub-market produces a model-based valuation of $171,135 for the subject property. Specifically, the value updates as the weighted average of adjusted comps. As the sub-market is refined, the model-based valuation automatically updates to include a valuation using the adjusted values for each of the updated pool of recent sales. The adjustments and weighting are performed using the model as described above. If desired, the user can also choose any number of the properties from a current pool to obtain a corresponding weighted valuation from those properties. In this fashion, the user can apply narrowing of the pool and/or selection in order to see where further refinements in the comp pool stop causing significant changes in the subject property valuation.

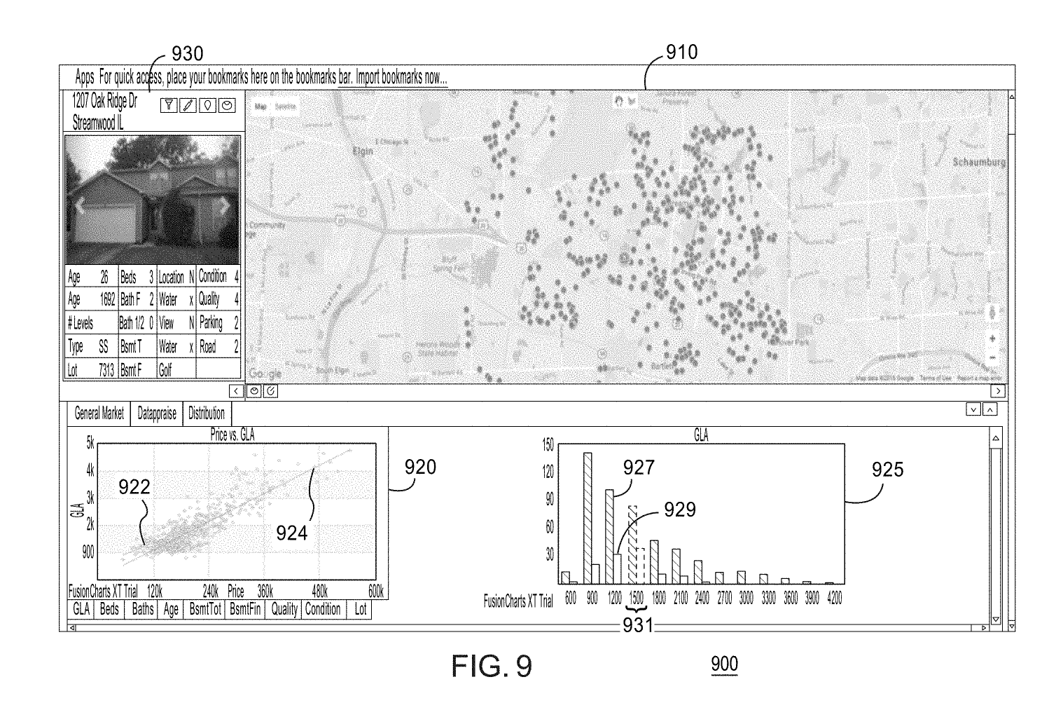

FIG. 9 is a display diagram 900 illustrating a subject property region 930 alongside a map image 910 of a current sub-market and graphical depictions of property characteristics information. The subject property region 930 identifies the subject property and may include a photo of the subject property. Related property characteristic information and icons including those to prompt filtering are also in the region 930. The map image 910 depicts the current state of the sub-market according to the current filter settings as previously described.

In lieu of property grid data (e.g., FIG. 5A, element 520a) the display diagram 900 is updated to include property characteristics distribution information for the currently depicted sub-market. Tabs may be used to allow the user to navigate among the property grid data view (e.g., General Market tab) and the property characteristics distribution information (e.g., Distribution tab). Examples of the property characteristics include GLA, Beds, Baths, Age, Basement Total, Basement Finished, Quality, Condition and Lot Size.

The property characteristics distribution information includes two graphs 920, 925.

The first graph 920 plots the data points for price against any given one of the indicated property characteristics. Various mechanisms may be used to receive user selection of a desired property characteristic to review. In this example, tabs respectively labelled according to the available property characteristics for review are provided. FIG. 9 illustrates an example where GLA is the characteristic. The graph illustrates how variations in GLA affect price. All of the data points for the general market are included, and the sub-market may be separately indicated (e.g., by a different color). Additionally, interpolation is used to indicate a functional relationship between the characteristic and price, along with respective lines 924, 922 indicating the same for the general and current sub-market. Generally, the graph is intended to show whether a large discrepancy exists between what is expected in the market or sub-market for any given property characteristic, against the individual values that any given property has for that characteristic. As is evident from the graph, the points on the graph respectively correspond to individual properties, and if the point for a property is far from the lines on the graph, then it may invite further review as to why the value accorded to that property differs so greatly from what is found on the graph. The “current” property under review is preferably accorded a highlighted point on the graph.

The second graph 925 corresponds to the same property characteristic and underlying property data as the first graph. However, the second graph 925 is a bar graph, with one axis being respective values for any given property characteristic and the other being the number of instances of properties having the respective values. For each value, the general market and the current sub-market are depicted by respective bars 927 (general), 929 (sub-market). Different colors are preferably used for the respective bars. That is each of the general market bars 927 will consistently have one color (e.g., orange) and each of the sub-market bars 929 will consistently have another color (e.g., green). Additionally, the instances of bars 927, 929 that correspond to the value present in the subject property may be highlighted to indicate as such, via a black dash line or the like. In FIG. 9, the particular instances of bars 927, 929 that correspond to the value present in the subject property are bracketed 931 for ease of illustration.

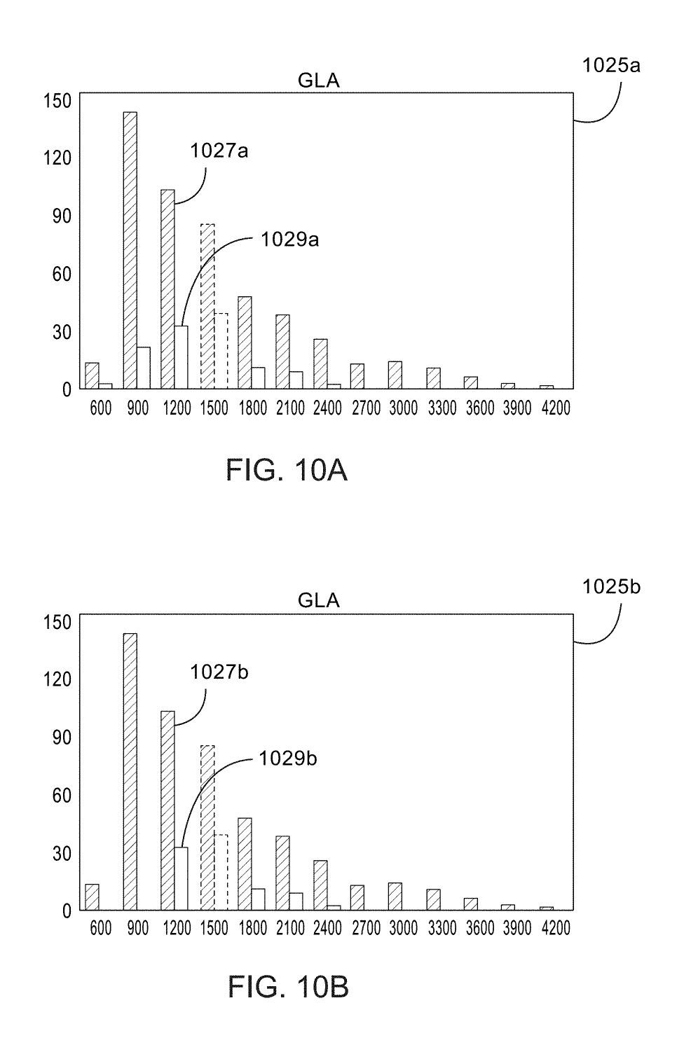

FIGS. 10A-B are respective display diagrams illustrating respective instances of property characteristics distribution graph 1025a-b with sub-market revision. That is, the distribution graph 1025a and bars 1027a, 1029a depict the distribution prior to a filtering operation (e.g., GLA 660-4280 sq. ft.), and distribution graph 1025b and bars 1027b, 1029b depict the distribution after a filtering operation. Specifically, the filtering operation represents the sub-market filtered according to properties with GLA between 1200 and 2300 sq. ft.

These graphs allow the user to review the impact of updates to filtering criteria upon the corresponding pool of properties in updated sub-markets. They can readily show how such filtering may skew against the housing stock in the general market. These features improve the computer application by allowing the user to readily observe such changes in a fashion that was never appreciable previously.

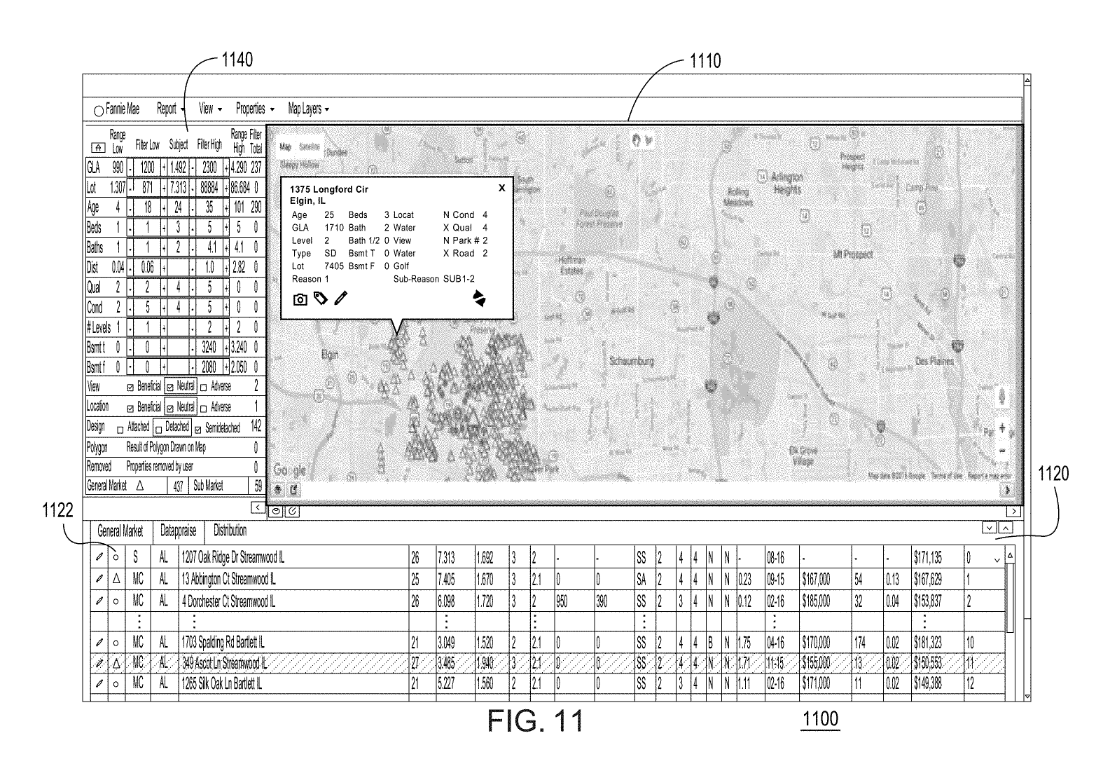

FIG. 11 is a display diagram 1100 illustrating subject property characteristics range information 1140 (for defining the current sub-market as described previously) alongside a map image for the current sub-market 1110 and a property grid listing 1120 with options for selecting individual properties for inclusion in and exclusion from the sub-market.

There are two basic ways to individually add and remove properties from a sub-market. Within the map image 1110 there are depictions of properties that are members of the current sub-market (e.g., green dots illustrated as darker dots) and properties that are not within the current sub-market (e.g., clear or white triangles). The user may navigate the cursor to any of these properties and click on the indicator for further operations. For example, the user may click on a triangle, whereupon a pop-up box with further information identifying the underlying property instantiates. The pop-up box has basic information about the property, preferably the address and significant property characteristics information. The pop-up box also preferably will include an indicator that allows the user to individually add the property to the sub-market. For example, this may be a thumbs up button, alluding to the user's indicating that the property is OK for inclusion as a result of the operation. By clicking on this indicator (button) another screen instantiates to invite input explaining why the property is being added. As explained above, the property would have been excluded from the sub-market initially, because it would be out of range for one or more of the filtering criteria. Thus, an explanation would be warranted. In some embodiments, the default will be that an explanation must be provided to allow the user to proceed with moving the property into the sub-market.

Various reasons may be provided. For example, the user may wish to add back a property that had been filtered out because it has some feature, usually distance, which makes it cry out to be included. So if the home next door was among the recent sales, but is more than 300 square feet different from the subject (if that was among the filters), the user still might include it because it is presumably highly relevant. Another example may be a home of the same rare style or one that has a similar astonishing view that was otherwise cut out, but might be the key reason someone is buying the subject. Also, with respect to property data, there are often problems with accessory units and basements (sometimes counted in GLA) in the data. So it may be desirable to override some descriptors for that reason.

Kicking properties out would usually happen when the user just doesn't believe the property should be a comp, even though it was not thrown out by filters. This might occur after looking at some pictures, where the user is skeptical about the quality or condition rating of the comp, but does not feel like updating the data. Or perhaps the comp appears to be a quality 3, on the boundary of quality 4, but the subject is more like a quality 3, on the cusp of 2—so the two homes appear pretty different.

Once the user has entered the explanation (whether for inclusion or exclusion), an “apply” or “submit” button may be used to complete the process.

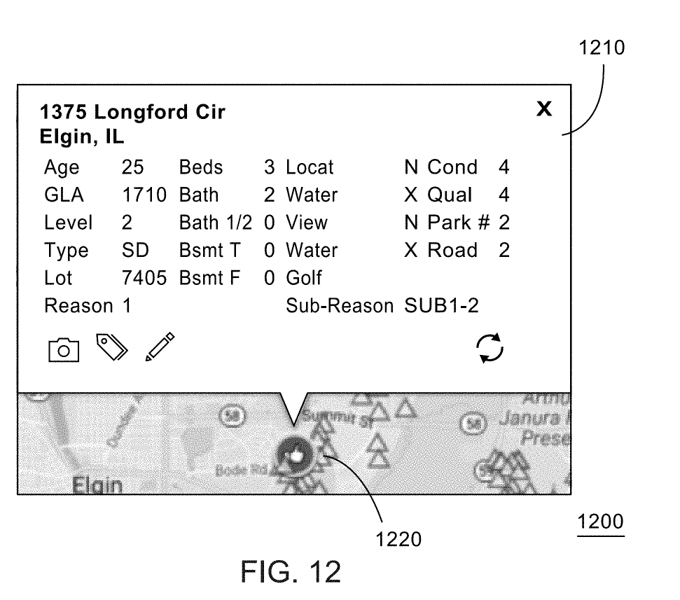

FIG. 12 is a display diagram 1200 illustrating an included property within a sub-market along with a corresponding indicator. As illustrated, the property may now show as a “thumbs up” indicator 1220 on the map image. Additionally, as is the case with all of the indicators on the map image, selecting the indicator prompts a screen 1210 identifying the property and providing overview information. By contrast, a thumbs down icon may be used for any properties that would have been included, but which are excluded individually as described above.

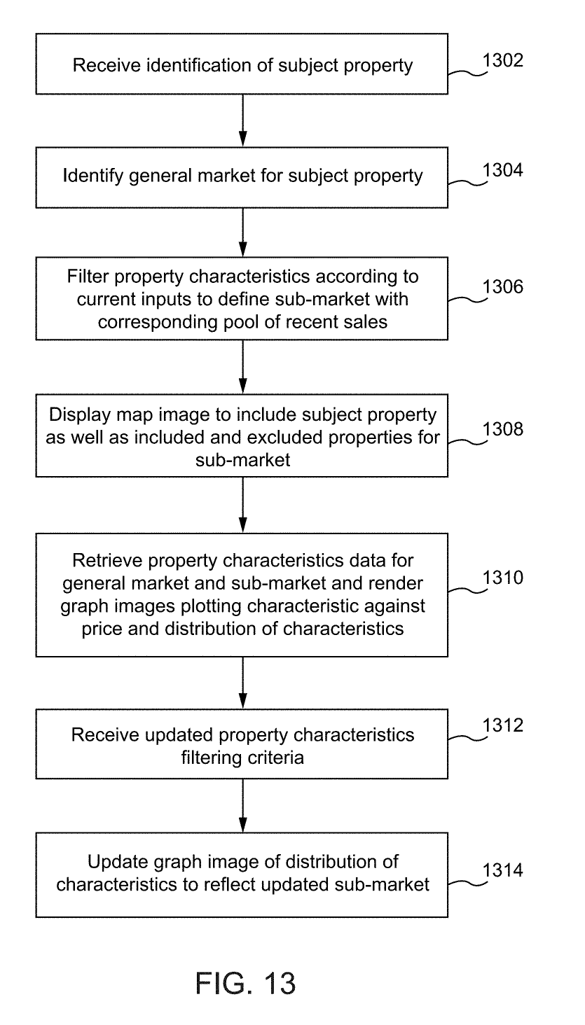

FIG. 13 is a flow diagram illustrating an example of determining and depicting property characteristic distributions in updatable sub-markets for a subject property. An identification 1302 of a subject property is initially received, such as though user selection. The general market for the subject property is then identified 1304, preferably according to a default set of conditions. This may be variously arranged but in one example is a predetermined number (e.g., 500) of the closest recent sales in distance from the subject. The general market may also be referred to as the default pool of sales.

From this default setting, the user may iteratively apply property characteristics filtering criteria 1306, 1312 to define and revise sub-markets corresponding to the subject property, with varying corresponding pools of recent sales in each sub-market. The property characteristics range-based user interface as previously described is preferably used to receive user input for one or more characteristics prior to each revision. For example, the user may revise property characteristics including GLA, Beds, Baths, Age, Basement Total, Basement Finished, Quality, Condition and Lot Size, as well as distance from the subject and special criteria such as view and location. Once the user submits the revised criteria, the map image is displayed 1308 to include the subject property (one indicator and corresponding color and/or shape, such as a gold star), the properties that remain included in the sub-market (another indicator and corresponding different color and/or different shape, such as green dots) and the properties that were in the general market but which are excluded from the current sub-market being depicted in the map image (still another indicator, such as white triangles).

Provided with the so-defined current sub-market, the appropriate property characteristics are retrieved 1301 and distribution of property characteristics graphical images are depicted for the sub-market accordingly. Each update 1314 of the property characteristics filtering criteria provides a new data set from which an updated 1314 graph of the distribution of property characteristics is generated. Examples of the graphical images are descripted above in relation to the comparable property analysis application and FIGS. 9 and 10A-B.

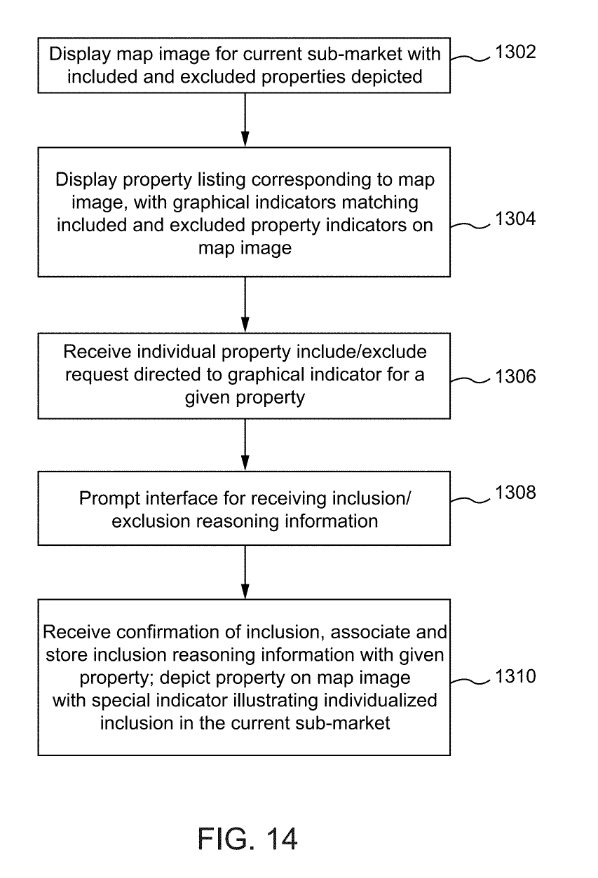

FIG. 14 is a flow diagram illustrating an example of displaying map images of sub-markets and receiving and recording inclusion and/or exclusion information for individual properties.

As explained, the user manipulates property characteristics to define a current sub-market, and from this a new map image is displayed 1402 along with indicators as to which properties are currently included and excluded. Additionally, a property data listing can be displayed 1404 along with the map image. Those listings are provided with indicators that match those provided in the map image. From this state, a user may selectively call up and change the status of any given property. Such an individual property include/exclude request may be received 1406 through the graphical indicator (e.g., the user clicks on a white triangle corresponding to a currently-excluded property, either on the map image or the listing). This prompts 1408 display of an interface that is used to confirm the process of switching the status and to receive a corresponding narrative explanation. An appropriate button is then used to prompt the application to receive 1410 confirmation of the inclusion of the property into the current sub-market. It is then displayed on the map image with a special indicator illustrating it is an individualized (user-driven) inclusion in the sub-market, and the corresponding explanation is retained for future review.

Thus embodiments of the present invention produce and provide methods and apparatus for displaying property sales, automatically updating sub-markets based upon filtered property characteristics, and determining property characteristic distribution information for such sub-markets. Although the present invention has been described in considerable detail with reference to certain embodiments thereof, the invention may be variously embodied without departing from the spirit or scope of the invention. Therefore, the following claims should not be limited to the description of the embodiments contained herein in any way.

1. A method for displaying a subject property along with pools of property sales, the method comprising:
receiving an identification of a subject property and identifying a general market for the subject property as a corresponding first pool of property sales that satisfy a first range of values for property characteristics corresponding to the subject property;
identifying a sub-market for the subject property as a corresponding second pool of property sales that satisfy a second range of values for the property characteristics, the second range being more narrow than the first range in at least one of the property characteristics;
receiving an identification of a selected property characteristic from among the property characteristics; and
generating and displaying distribution information for the selected property characteristic for the general market and the sub-market.

2. The method of claim 1, further comprising:
displaying a graphical image of the distribution information, the graphical image correlating respective values for the selected property characteristic to respective numbers of instances of the respective values for the general market and the sub-market.

3. The method of claim 1, further comprising:
displaying a graphical image correlating respective values for the selected property characteristic to price for the general market and the sub-market.

4. The method of claim 1, further comprising:
receiving a request to include an individual property sale in the sub-market;
displaying a user-input interface for the individual property;
receiving explanation information and a confirmation to include the individual property in the sub-market from the user-input interface; and
updating the sub-market to include the individual property sale.

5. The method of claim 1, further comprising:
receiving a request to exclude an individual property sale in the sub-market;
displaying a user-input interface for the individual property;
receiving explanation information and a confirmation to exclude the individual property in the sub-market from the user-input interface; and
updating the sub-market to exclude the individual property sale.

6. A non-transitory computer readable medium storing program code for displaying a subject property along with pools of property sales, the program code being executable by a processor to perform operations comprising:
receiving an identification of a subject property and identifying a general market for the subject property as a corresponding first pool of property sales that satisfy a first range of values for property characteristics corresponding to the subject property;
identifying a sub-market for the subject property as a corresponding second pool of property sales that satisfy a second range of values for the property characteristics, the second range being more narrow than the first range in at least one of the property characteristics;
receiving an identification of a selected property characteristic from among the property characteristics; and
generating and displaying distribution information for the selected property characteristic for the general market and the sub-market.

7. The computer readable medium of claim 6, wherein the operations further comprise:
displaying a graphical image of the distribution information, the graphical image correlating respective values for the selected property characteristic to respective numbers of instances of the respective values for the general market and the sub-market.

8. The computer readable medium of claim 6, wherein the operations further comprise:
displaying a graphical image correlating respective values for the selected property characteristic to price for the general market and the sub-market.

9. The computer readable medium of claim 6, wherein the operations further comprise:
receiving a request to include an individual property sale in the sub-market;
displaying a user-input interface for the individual property;
receiving explanation information and a confirmation to include the individual property in the sub-market from the user-input interface; and
updating the sub-market to include the individual property sale.

10. The computer readable medium of claim 6, wherein the operations further comprise:
receiving a request to exclude an individual property sale in the sub-market;
displaying a user-input interface for the individual property;
receiving explanation information and a confirmation to exclude the individual property in the sub-market from the user-input interface; and
updating the sub-market to exclude the individual property sale.

11. An apparatus for displaying a subject property along with pools of property sales, the apparatus comprising:
a processor; and
a memory, the memory storing program code executable by the processor to perform operations comprising:
receiving an identification of a subject property and identifying a general market for the subject property as a corresponding first pool of property sales that satisfy a first range of values for property characteristics corresponding to the subject property;
identifying a sub-market for the subject property as a corresponding second pool of property sales that satisfy a second range of values for the property characteristics, the second range being more narrow than the first range in at least one of the property characteristics;
receiving an identification of a selected property characteristic from among the property characteristics; and
generating and displaying distribution information for the selected property characteristic for the general market and the sub-market.

12. The apparatus of claim 11, wherein the operations further comprise:
displaying a graphical image of the distribution information, the graphical image correlating respective values for the selected property characteristic to respective numbers of instances of the respective values for the general market and the sub-market.

13. The apparatus of claim 11, wherein the operations further comprise:
displaying a graphical image correlating respective values for the selected property characteristic to price for the general market and the sub-market.

14. The apparatus of claim 11, wherein the operations further comprise:
receiving a request to include an individual property sale in the sub-market;
displaying a user-input interface for the individual property;
receiving explanation information and a confirmation to include the individual property in the sub-market from the user-input interface; and
updating the sub-market to include the individual property sale.

15. The apparatus of claim 11, wherein the operations further comprise:
receiving a request to exclude an individual property sale in the sub-market;
displaying a user-input interface for the individual property;
receiving explanation information and a confirmation to exclude the individual property in the sub-market from the user-input interface; and
updating the sub-market to exclude the individual property sale.
